(19) United States
(12) Patent Application Publication
(10) Pub. No.: US 2006/0078743 A1
(43) Pub. Date: Apr. 13, 2006

(54) Window shade and a multi-layered article, and methods of making the same

(76) Inventors: Sheri Champlin, Golden, CO (US); Constantin Donea, Evansville, IN (US)

Correspondence Address: CANTOR COLBURN, LLP, 55 GRIFFIN ROAD SOUTH, BLOOMFIELD, CT, 06002, US

(21) Appl. No.: 10/960,413

(22) Filed: Oct. 7, 2004

(51) Int. Cl. B32B 27/36

(52) U.S. Cl. 428/412

(57) ABSTRACT

A window shade comprises a core layer comprising a core layer thermoplastic resin, and an opacity additive; and a cap layer comprising a cap layer thermoplastic resin, and an aesthetic additive.

### BACKGROUND

The cabin of an aircraft generally comprises windows that allow light into the cabin and allow passengers to view out of the cabin. These windows are generally equipped with window shades that, when engaged (e.g., pulled down over the window), can block light transmission into the aircraft cabin. For example, the window shades can include a shade material that has uniform light transmission capabilities, e.g., the window shade can be made of a material that is opaque (i.e., no light is transmitted through the window shade). Various processes have been employed to form aircraft window shades, which can be expensive, time consuming, and the like.

What are needed in the art are aircraft window shades that are opaque and cosmetically compatible with the interior of the aircraft cabin, as well as processes for making such window shades.

### SUMMARY

Disclosed herein are window shades and multi-layered articles, and methods of making the same.

One embodiment of a window shade comprises a core layer comprising a core layer thermoplastic resin, and an opacity additive; and a cap layer comprising a cap layer thermoplastic resin, and an aesthetic additive.

One embodiment of an aircraft window shade comprises a core layer comprising a core layer thermoplastic, an opacity additive in a sufficient amount such that the core layer is opaque, and a flame retardant additive in a sufficient amount such that the aircraft window shade can at least pass a 12 second vertical burn test as set forth in FAR 25.853, Appendix F, part I(b)(4); and a cap layer comprising a cap layer thermoplastic and aesthetic additive in a sufficient amount such that the core layer cannot be seen through the cap layer when the air craft window shade is placed in sunlight.

One embodiment of a method of making a window shade comprises forming a multi-layer film, wherein the multi-layer film comprises a core layer comprising a core layer thermoplastic resin, and an opacity additive; and a cap layer comprising a cap layer thermoplastic resin, and an aesthetic additive, and thermoforming the multi-layer film to form the window shade.

One embodiment of a multi-layered article comprises a core layer comprising a core layer thermoplastic, an opacity additive in a sufficient amount such that the core layer is opaque, and a cap layer comprising a cap layer thermoplastic and aesthetic additive in a sufficient amount such that the core layer cannot be seen through the cap layer when the multi-layered article is placed in sunlight.

The above-described and other features will be appreciated and understood by those skilled in the art from the following detailed description, drawings, and appended claims.

### BRIEF DESCRIPTION OF THE DRAWINGS

Referring now to the figures, which are exemplary embodiments, and wherein the like elements are numbered alike:

FIG. 1 is a cross sectional view of an embodiment of an aircraft window shade;

FIG. 2 is a schematic view of an embodiment of an extrusion system for making a multi-layered film used in an aircraft window shade; and

FIG. 3 is a schematic view of an embodiment of a lamination system for making a multi-layered film used in an aircraft window shade.

### DETAILED DESCRIPTION

Disclosed herein are multi-layer films, which can be employed in window shades, more particularly aircraft window shades. While reference is made to an aircraft window shade throughout this disclosure, it is to be understood by those skilled in the art that the multi-layer film disclosed herein can be employed as a window shade in other applications (e.g., trains, buses, ships, residential and commercial buildings, and the like), as well as in a variety of other articles (e.g., wall panels, and the like).

It should first be noted that the terms “first,” “second,” and the like herein do not denote any order, quantity, or importance, but rather are used to distinguish one element from another, and the terms “a” and “an” herein do not denote a limitation of quantity, but rather denote the presence of at least one of the referenced item. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” is inclusive of the endpoints and all intermediate values of the ranges, e.g., “about 5 wt. % to about 25 wt. %, about 5 wt. % to about 15 wt. %,” etc.).

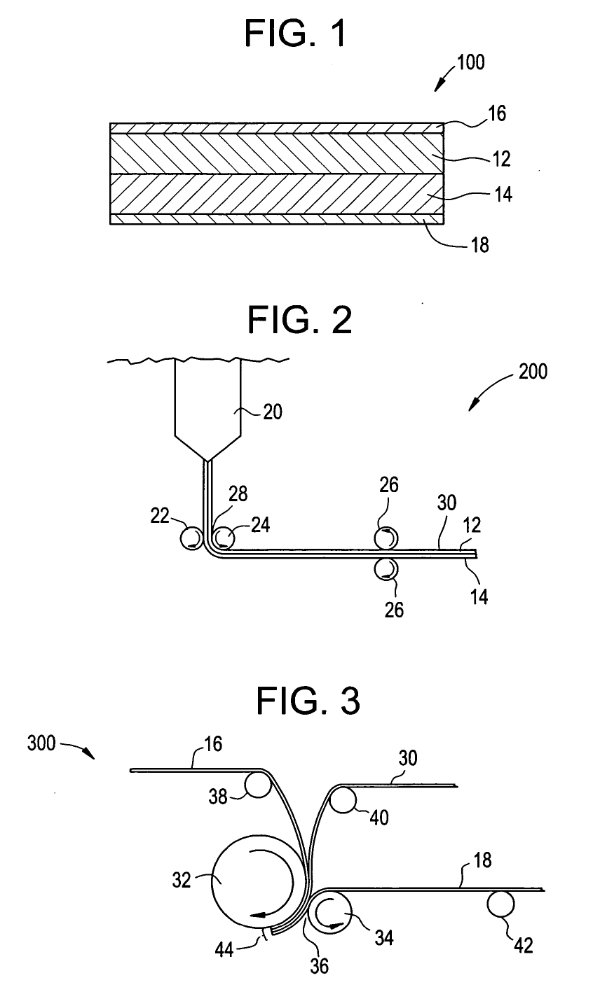

Referring now to FIG. 1, a cross sectional view of an aircraft window shade, generally designated 100, is illustrated. The window shade 100 can comprise a first layer (core layer) 12, which can render the window shade opaque; and a second layer (cap layer) 14, which can cover (hide) the core layer 12, e.g., for aesthetic purposes. The core layer 12 can be disposed in physical communication with the cap layer 14. Furthermore, the window shade 100 can further comprise additional layers (e.g., third layer 16 and/or forth layer 18) depending on the desired application (e.g., the desired aesthetic appearance of aircraft cabin interior, and the like). Moreover, it is generally noted that the overall size, shape, thickness, opacity, and the like, of window shade 100 can vary depending on the desired application. With regards to the opacity of the window shade 100, it is briefly noted that end user specifications (e.g., commercial airline specifications) generally specify that the window shade 100 is opaque. However, it is to be understood that some end users may not demand an opaque window shade 100. As such, embodiments are envisioned wherein the window shade can have some light transmission therethrough. For example, the window shade can have a light transmission of 0% to about 50%, more particularly 0% to about 10% as measured by American Society for Testing and Materials (ASTM) D1003.

Core layer 12 can comprise an extrudable thermoplastic composition that is compatible with the cap layer 14, and optionally compatible with any optional layer (e.g., third layer 16) disposed in physical communication with the core layer 12. More particularly, core layer 12 can comprise a thermoplastic resin, an opacity additive (e.g., a colorant (such as a dye, pigment, and the like), filler, and/or the like), a flame retardant, and optionally, various other additives.

With regards to the thermoplastic resin, it is advantageously noted that a recycled thermoplastic resin can be employed in making the core layer 12. It is to be understood that the recycled thermoplastic resin can included process recycle (e.g., scrap material generated during the manufacturing process) and can also include end user (e.g., consumer) recycle materials. Furthermore, since recycle materials generally cost less than non-recycled materials (e.g., “new” materials), a core layer 12 produced using recycled materials can advantageously cost less than a core layer 12 produced with new materials.

Suitable thermoplastic resins that may be employed in core layer 12 include, but are not limited to, oligomers, polymers, ionomers, dendrimers, copolymers such as block copolymers, graft copolymers, star block copolymers, random copolymers, and combinations comprising at least one of the foregoing. Examples of such thermoplastic resins include, but are not limited to, polycarbonates, polystyrenes, copolymers of polycarbonate and styrene, polycarbonate-polybutadiene blends, blends of polycarbonate, copolyester polycarbonates, polyetherimides, polyimides, polypropylenes, acrylonitrile-styrene-butadiene, polyphenylene ether-polystyrene blends, polyalkylmethacrylates such as polymethylmethacrylates, polyesters, copolyesters, polyolefins such as polypropylenes and polyethylenes, high density polyethyelenes, low density polyethylenes, linear low density polyethylenes, polyamides, polyamideimides, polyarylates, polyarylsulfones, polyethersulfones, polyphenylene sulfides, polytetrafluoroethylenes, polyethers, polyether ketones, polyether etherketones, polyacrylics, polyacetals, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazzanes, polysiloxanes, polyvinylchlorides, and combinations comprising at least one of the foregoing.

More particularly, the thermoplastic resins can include, but are not limited to, polycarbonate resins (e.g., Lexan® resins, commercially available from the General Electric Company), polyphenylene ether-polystyrene blends (e.g., Noryl® resins, commercially available from the General Electric Company), polyetherimide resins (e.g., Ultem® resins, commercially available from General Electric Company), polybutylene terephthalate-polycarbonate blends (e.g., Xenoy® resins, commercially available from the General Electric Company), copolyestercarbonate resins (e.g. Lexan® SLX resins, commercially available from the General Electric Company), and combinations comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins.

The opacity additive employed in the core layer 12 can be a colorant. Suitable colorants include, but are not limited to, titanium dioxide, zinc sulfide, zinc oxide, barium sulfate, carbon black, iron oxides, cobalt aluminates, chrome oxides, nickel titanates, molybdenum oxides, chrome copper oxides, ultramarine blue, phthalocyanines, quinacridones, perylenes, anthraquinones, isoindolinones, and combinations comprising the foregoing.

The core layer 12 can further comprise an effective amount of a flame retardant such that core layer 12 and ultimately window shade 100 can meet Federal Aviation Regulation (FAR) 25.853 (air worthiness standard for aircraft compartment interiors), which sets the fire protection requirements for a compartment (cabin) interior of an aircraft, and more particularly can meet Appendix F, part I(b)(4) of FAR 25.853. Suitable flame retardants include, but are not limited to, halogenated resins (e.g., brominated resins, chlorinated resins, and the like), antimony oxide fillers, organic phosphates, and combinations comprising at least one of the foregoing. In an embodiment, the flame retardant can be a brominated polycarbonate copolymer present in an amount of about 2 wt. % to about 80 wt. %, more particularly about 20 wt. % to about 60 wt. %, wherein weight percents are based on a total weight of the core layer 12.

As briefly noted above, the core layer 12 can optionally further comprise an effective amount of an additive. Suitable additives include, but are not limited to anti-oxidants, drip retardants, stabilizers (e.g., thermal, light, and the like), antistatic agents, plasticizers, impact modifiers, lubricants, reinforcing agents, ultra violet (UV) absorbers, and combinations comprising at least one of the foregoing. It is noted that the effective amounts of the additives can vary widely, but can generally be present in an amount up to about 30 wt. %, wherein the weight percent is based on a total weight of the core layer 12.

In an embodiment, core layer 12 can comprise a sufficient thickness and a sufficient amount and type of opacity additive to render the core layer opaque. For example, the core layer 12 can comprise a thickness of about 0.2 millimeters (mm) to about 5 mm, more particularly a thickness of about 0.3 mm to about 1 mm. When the opacity additive is carbon black, the core layer 12 can comprise about 0.1 weight percent (wt. %) to 10 about wt. % of the carbon black, more particularly about 0.2 to about 2 wt. %, wherein the weight percents are based on a total weight of the core layer 12.

Cap layer 14 can comprise an extrudable thermoplastic composition that is compatible with core layer 12, and optionally compatible with any optional layer (e.g., fourth layer 18) that is disposed in physical communication with the cap layer 14. More particularly, the cap layer 14 can comprise a thermoplastic resin, an aesthetic additive, and various optional other additives. Suitable thermoplastic resins include, but are not limited to, those resins discussed above with regards to core layer 12. For example, the cap layer 14 can be formed from a polycarbonate resin, such as Lexan® resin, commercially available from General Electric Company. Additionally, it is noted that suitable aesthetic additives can include those materials discussed above in relation to the opacity additive of the core layer 12. More particularly, in an embodiment, the aesthetic additive can comprise titanium dioxide.

The cap layer 14 can comprise a sufficient thickness and a sufficient amount and type of aesthetic additive to cover core layer 12 such that the core layer 12 cannot be seen through cap layer 14. More particularly, embodiments are envisioned where the core layer 12 cannot be seen through the cap layer 14 even when the window shade is thermoformed using a deep draw method up to about 50 mm, and the resulting shade is placed against sunlight. For example, the cap layer 14 can comprise a thickness of about 0.2 mm to about 5 mm, more particularly a thickness of about 0.25 mm to about 1 mm. When the aesthetic additive is titanium dioxide, the cap layer 14 can comprise about 1 wt. % to about 25 wt. % of the titanium dioxide, more particularly about 4 wt. % to about 16 wt. %, wherein the weight percents are based on a total weight of the cap layer 14.

With regards to optional layer(s) (e.g., third layer 16, fourth layer 18, and the like), it is noted that the optional layers can be disposed in physical communication with the core layer 12 and/or cap layer 14. It is briefly noted that these optional layers can act as a tie layer (adhesive layer) between, for example, core layer 12 and/or cap layer 14. Additionally/alternatively, these optional layers can comprise a surface of the window shade 100, e.g., for aesthetic purposes. Each optional layer can comprise an extrudable thermoplastic composition comprising a thermoplastic resin, such that each optional layer can be compatible with core layer 12, cap layer 14, and/or any other optional layer(s) that are disposed in physical communication with each given optional layer. Suitable thermoplastic resins include, but are not limited to, those resins discussed above in relation to core layer 12. More particularly, the optional layers can each comprise a polyvinyl fluoride (PVF) resin, e.g., for aesthetic purposes. As briefly mentioned above, it is to be understood that the thickness of each layer, the number of layers, arrangement of layers, and the like, can vary in embodiments of the multi-layer film employed in making the window shade 100.

The multi-layer film (e.g., a film comprising core layer 12, cap layer 14, and optional third and forth layers 16, 18) that can be employed in making the window shade 100 can be produced by a number of suitable methods. For example, core layer 12 and cap layer 14 can be co-extruded to form a dual layer film, which can optionally then be rolled (stored) to be subsequently processed (e.g., laminated with optional third and fourth layers 16,18). Alternatively, the dual layer film can be fed directly to a lamination area where the optional third and/or fourth layers (16, 18) can be laminated onto the dual layer film. In other embodiments, an extrusion-lamination method can be employed wherein the co-extruded core layer 12 and cap layer 14 can be laminated with optional third and fourth layers (16, 18) while the core layer 12 and the cap layer 14 are in a softened state. In yet another embodiment, the core layer 12, cap layer 14, third layer 16, and fourth layer 18 can all be co-extruded to form the multi-layer film. It is briefly noted with regards to co-extrusion of the multi-layers that a single manifold die or a multi-manifold die can be employed depending on the given properties (e.g., glass transition temperature (T_{g})) for each thermoplastic resin in each layer).

Referring to FIG. 2, a schematic view of an exemplary extrusion system, generally designated 200, is illustrated. It is briefly noted that while the extrusion system 200 is discussed in relation to the extrusion of a dual layer film 30 comprising the core layer 12 and cap layer 14, it is to be understood that the system can optionally be adapted for the extrusion of a multi-layer film (e.g., a film comprising core layer 12, cap layer 14, third layer 16 (FIG. 1), and/or fourth layer 18 (FIG. 1)). The system 200 can comprise a slot die 20, a first calendering roll 22, a second calendering roll 24, and pull rolls 26. A nip 28 (or gap) can be formed between the first calendering roll 22 and the second calendering roll 24. In this illustration, the slot die 20 is perpendicular to the first and second calendering rolls (22, 24). However, it is to be understood that other embodiments are envisioned where the slot die 20 is parallel to the first and second calendering rolls (22,24) and where the slot die 20 is disposed at an angle relative to the first and second calendering roll (22, 24).

In operation, a molten thermoplastic composition(s) (e.g., a thermoplastic composition that has been heated to a temperature greater than a glass transition temperature (T_{g}) of the thermoplastic composition) can be extruded from slot die 20. The molten thermoplastic composition can then be passed through the nip 28, which when cooled can form the dual layered film 30. Having passed the molten thermoplastic composition through the nip 28, the thermoplastic composition can be cooled (e.g., to a temperature less than the T_{g} of the thermoplastic composition), and can then be passed through pull rolls 26. As discussed above, the cooled dual layer film 30 can optionally be rolled (stored) to be subsequently processed (e.g., laminated), or the dual layer film 30 can be feed directly to a lamination area.

In various embodiments, the calendering roll(s) (22, 24) can comprise a polished roll (e.g., a chrome or chromium plated roll). In other embodiments, the roll(s) can comprise a textured roll (e.g., a roll comprising an elastomeric material (e.g., an EPDM (ethylene propylene diamine monomer) based rubber)). Suitable materials for the rolls include plastic, metal (e.g., chrome, stainless steel, aluminum, and the like), rubber (e.g., EPDM), ceramic materials, and the like. Furthermore, it is generally noted that the size of the rolls, material of the rolls, number of rolls, the film wrap around the rolls, and the like, can vary with the system employed. Further, it is noted that processing conditions (e.g., the temperature of the calendering rolls, the line speed, nip pressure, and the like) can also be varied.

In an embodiment, the dual layer film (e.g., 30) can be laminated with additional films (layers) to form a multi-layered film. Referring to FIG. 3, an exemplary lamination system, generally designated 300, is illustrated. The system 300 can comprise a first laminating roll 32 and a second laminating roll 34 with a nip 36 formed between the first laminating roll 32 and the second laminating roll 34. Third layer 16, dual layer film 30, and fourth layer 18 can each be supplied to the nip 36 via rolls 38, 40, and 42 respectively. A resulting multi-layer film 44 can be produced when the final film cools. The multi-layer film 44 can optionally be rolled (stored) in a manner described above or alternatively the film 44 can be supplied directly to a thermoforming station where the multi-layer film 44 can be cut and thermoformed into window shade 100 (FIG. 1).

It is generally noted that the term “thermoforming” is used to describe a method that comprises the sequential or simultaneous heating and forming of a material onto a mold, wherein the material is originally in the form of a sheet (e.g., film, layer, and the like) and is formed into a desired shape. Once the desired shape has been obtained, the formed article (e.g., window shade 100) is cooled below its glass transition temperature. For example, suitable thermoforming methods include, but are not limited to, mechanical forming (e.g., matched tool forming), membrane assisted pressure/vacuum forming, membrane assisted pressure/vacuum forming with a plug assist, and the like.

### EXAMPLE

In this example, dual layer polycarbonate sheets comprising a core layer (e.g., 12) and cap layer (e.g., 14) were extruded as described above. The thickness of each layer was varied, as well as the bromine concentration in the core layer and the titanium dioxide concentration in the cap layer. These concentrations were expressed as weight percents based on the total weight of each respective layer. For example, the weight percents of bromine and carbon black shown in Table 1 were based on the total weight of the core layer, with the balance being polycarbonate. The titanium dioxide concentration shown in Table 1 was based on the total weight of the cap layer, with the balance being polycarbonate.

For each sample, the dual layer film was evaluated for opacity. More particularly, each film was evaluated to determine if the film was opaque (i.e., no light was transmitted through the film) by ASTM D 1003. If the film was opaque a “Yes” was recorded for opacity, and a “No” was recorded if the film was not opaque. Similarly, the aesthetic appearance of dual layer films that were thermoformed with a 20 mm deep draw method was evaluated. If the core layer could be seen, the film did not meet the aesthetic test and a “No” was recorded. If the core layer could not be seen, the film met the aesthetic test and a “Yes” was recorded.

Furthermore, each sample was tested per the “vertical burn” test specified in FAR 25.853 for 12 seconds (s) and 60 seconds, as referenced in Appendix F, part I. If a sample passed the test, a “pass” was recorded; and if sample failed the test, a “fail” was recorded. These results are summarized in Table 1.

TABLE 1

| | Core layer | Bromine | Carbon | Cap layer | TiO₂ | | | 12 s | 60 s |
|---|---|---|---|---|---|---|---|---|---|
| | thickness | conc. | black conc. | thickness | content | Opaque | Aesthetic | vertical | vertical |
| # | inches (cm) | (wt. %) | (wt. %) | inches (cm) | (wt. %) | (Y/N) | (Y/N) | burn (P/F) | burn (P/F) |
| 1 | 0.030 (0.076) | 10 | 1 | 0.012 (0.030) | 12 | Yes | Yes | Pass | Pass |
| 2 | 0.024 (0.061) | 10 | 1 | 0.018 (0.046) | 12 | Yes | Yes | Pass | Pass |
| 3 | 0.018 (0.046) | 10 | 1 | 0.025 (0.064) | 12 | Yes | Yes | Pass | Pass |
| 4 | 0.031 (0.079) | 7.5 | 1 | 0.015 (0.038) | 12 | Yes | Yes | Pass | Fail |
| 5 | 0.026 (0.066) | 5 | 1 | 0.020 (0.051) | 8 | Yes | Yes | Pass | Fail |
| 6 | 0.034 (0.083) | 7.5 | 1 | 0.012 (0.030) | 8 | Yes | No | Pass | Pass |
| 7 | 0.046 (0.12) | 7.5 | 1 | 0 | — | Yes | No | Pass | Pass |
| 8 | 0.015 (0.038) | 7.5 | 1 | 0 | — | No | No | Pass | Pass |

It was noted that the core layer comprised a carbon black concentration of 1 wt. % and a bromine concentration greater than 5 wt. % for each sample. Moreover, it was noted that samples that had a core layer comprising 10 wt. % bromine and a cap layer that had a titanium dioxide concentration of 12 wt. % were all found both opaque and aesthetic, and passed the 12 second vertical burn test and 60 second burn test.

Advantageously, the aircraft window shades and methods of making the window shades disclosed herein can offer a number of advantages over various other aircraft window shades and methods of making the window shades. More particularly, it is noted that the aircraft window shade can be made using recycled thermoplastic resins, which generally cost less than the same “new” materials, thereby lowering the overall material cost in making the aircraft window shade. For example, the core layer 12 can comprise about 0 wt. % to about 100 wt. % recycled thermoplastic resin, more particularly about 75 wt. % to about 90 wt. %, wherein weight percents are based on a total weight of the core layer 12. Also, the cap layer 14 can comprise about 0 wt. % to about 100 wt. % recycled thermoplastic resin, more particularly about 0 wt. % to about 20 wt. %, wherein weight percents are based on a total weight of the cap layer 14.

With regards to the methods of making, it is noted that methods disclosed herein extrude two or more layers, which allows a multi-layer film (e.g., dual layer film 30) to be made at a reduced cost compared to a multi-layer film where each and every layer is first extruded, stored (rolled), and then laminated together. In other words, without being bound by theory, as the method of making the multi-layer film becomes more and more streamlined (e.g., as process steps are eliminated), the overall time spend in making the multi-layer film can be reduced as well as the amount of equipment employed in the process can be reduced, thereby lowering the overall processing costs.

Furthermore, an unexpected advantage can be realized over other window shades that comprise an opaque board (e.g., a cellulose based material impregnated with carbon black) laminated on the thermoplastic layer. In this example, the carbon black can flake off the thermoplastic layer, which can create black dust in the aircraft cabin and reduce the useful life of the window shade. Without being bound by theory, the aircraft window shades disclosed herein do not have materials that readily flake off, since the opacity additive (e.g., carbon black) are extruded with a thermoplastic resin to form a core layer with the desired opacity. Additionally, it is note that by adding an aesthetic additive (e.g., titanium dioxide) to a cap layer (e.g., 14), which is co-extruded with the core layer (12), the overall thickness of the aircraft window shade can be reduced, thereby reducing the total amount of material employed in the aircraft window shade and reducing the total cost of the aircraft window shade. Furthermore, a reduction in the material employed can lead to a lighter weight aircraft window shade compared to a thicker window shade comprising the same materials.

Additionally, it is noted that advantages can also be recognized for applications were the multi-layer film is not employed as a window shade. For example, as noted above, recycled materials can be employed in making the multi-layer film, thereby reducing the overall cost of the multi-layer film compared to a multi-layer film made with new materials.

While the invention has been described with reference to several embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A window shade comprising:
a core layer comprising a core layer thermoplastic resin, and an opacity additive; and
a cap layer comprising a cap layer thermoplastic resin, and an aesthetic additive.

2. The window shade of claim 1, wherein the opacity additive is carbon black.

3. The window shade of claim 2, wherein the carbon black is present in an amount of about 0.1 wt. % to about 10 wt. %, wherein weight percents are based on a total weight of the core layer.

4. The window shade of claim 2, wherein the carbon black is present in an amount of about 0.2 wt. % to about 2 wt. %.

5. The window shade of claim 1, wherein the window shade is an aircraft window shade, and wherein the core layer composition further comprises a sufficient amount of a flame retardant such that the aircraft window shade can pass at least a 12 second burn test as set forth in FAR 25.853, Appendix F, part I(b)(4).

6. The window shade of claim 5, wherein the flame retardant is a brominated polycarbonate copolymer present in an amount of about 2 wt. % to about 80 wt. %, wherein weight percents are based on a total weight of the core layer.

7. The window shade of claim 5, wherein the brominated polycarbonate copolymer is present in an amount of about 20 wt. % to about 60 wt. %.

8. The window shade of claim 1, wherein the core layer comprises a thickness of about 0.2 mm to about 5 mm.

9. The window shade of claim 1, wherein the core layer thermoplastic resin, the cap layer thermoplastic resin, or a combination of the foregoing comprise a homopolymer or a copolymer of a polycarbonate, a polyester, a polyacrylate, a polyamide, a polyetherimide, polyphenylene ether, or a combination comprising one or more of the foregoing resins.

10. The window shade of claim 1, wherein the core layer is opaque.

11. The window shade of claim 1, wherein the aesthetic additive is titanium dioxide.

12. The window shade of claim 11, wherein the titanium dioxide is present in amount of about 1 wt. % to about 25 wt. %, wherein weight percents are based on a total weight of the cap layer.

13. The window shade of claim 12, wherein the titanium dioxide is present is present in an amount of about 4 wt. % to about 16 wt. %.

14. The window shade of claim 1, further comprising a third layer disposed in physical communication with the core layer and a fourth layer disposed in physical communication with the cap layer.

15. An aircraft window shade comprising:
a core layer comprising a core layer thermoplastic, an opacity additive in a sufficient amount such that the core layer is opaque, and a flame retardant additive in a sufficient amount such that the aircraft window shade can pass at least a 12 second vertical burn test as set forth in FAR 25.853, Appendix F, part I(b)(4); and
a cap layer comprising a cap layer thermoplastic and aesthetic additive in a sufficient amount such that the core layer cannot be seen through the cap layer when the aircraft window shade is placed in sunlight.

16. The aircraft window shade of claim 15, wherein opacity additive is carbon black and the aesthetic additive is titanium dioxide, wherein the carbon black is present in an amount of about 0.1 wt. % to about 10 wt. % based on a total weight of the core layer, and wherein the titanium dioxide is present in amount of about 1 wt. % to about 25 wt. % based on a total weight of the cap layer.

17. A method of making a window shade, the method comprising:
forming a multi-layer film, wherein the multi-layer film comprises a core layer comprising a core layer thermoplastic resin, and an opacity additive; and
a cap layer comprising a cap layer thermoplastic resin, and an aesthetic additive; and
thermoforming the multi-layer film to form the window shade.

18. The method of claim 17, wherein the forming the multi-layer film further comprises coextruding the core layer and the cap layer.

19. The method of claim 18, wherein the forming the multi-layer film further comprises coextruding a third layer and a fourth layer.

20. The method of claim 17, wherein the forming the multi-layer film further comprises coextruding the core layer and the cap layer, laminating a third layer in physical communication with the core layer, and laminating a fourth layer in physical communication with the cap layer.

21. The method of claim 17, wherein the forming the multi-layer film further comprises laminating a third layer on a dual layer film comprising the core layer and the cap layer such that the third layer is in physical communication with the core layer and laminating a fourth layer on the dual layer film such that the fourth layer is in physical communication with the cap layer.

22. A multi-layered article, comprising:
a core layer comprising a core layer thermoplastic, an opacity additive in a sufficient amount such that the core layer is opaque, and
a cap layer comprising a cap layer thermoplastic and aesthetic additive in a sufficient amount such that the core layer cannot be seen through the cap layer when the multi-layered article is placed in sunlight.

23. The aircraft window shade of claim 22, wherein opacity additive is carbon black and the aesthetic additive is titanium dioxide, wherein the carbon black is present in an amount of about 0.1 wt. % to about 10 wt. % based on a total weight of the core layer, and wherein the titanium dioxide is present in amount of about 1 wt. % to about 25 wt. % based on a total weight of the cap layer.
